(19) United States
(12) Patent Application Publication
(10) Pub. No.: US 2011/0285673 A1
(43) Pub. Date: Nov. 24, 2011

(54) WRITING DEVICE FOR ELECTRONIC PAPER AND WRITING METHOD THEREOF

(75) Inventors: Show-Chung Ho, Hsinchu City (TW); Su-Cheng Liu, Hsinchu City (TW); Ming-Chuan Hung, Hsinchu City (TW)

(73) Assignee: E Ink Holdings Inc., Hsinchu (TW)

(21) Appl. No.: 12/873,880

(22) Filed: Sep. 1, 2010

(30) Foreign Application Priority Data
May 20, 2010 (TW) 099116163

(51) Int. Cl. G09G 3/34; G09G 5/00

(52) U.S. Cl. 345/204; 345/107

(57) ABSTRACT

A writing method for E-paper includes the following steps. A writing device for E-paper is provided, which includes a first writing electrode and a second writing electrode facing to the first writing electrode. A writing space is defined between the first writing electrode and the second writing electrode. Next, an E-paper is disposed into the writing space. Next, a voltage is applied on the first writing electrode and/or the second writing electrode to generate an electric field in the writing space. Next, the first writing electrode and the second writing electrode are driven to move with respective to the E-paper so that the E-paper is written by the electric field in the writing space. The E-paper can be written without a writing circuit configured therein by the writing method, thereby the production cost of the E-paper can be reduced and the E-paper is facilitated to carry. Furthermore, A writing device for E-paper is also provided.

### CROSS-REFERENCE TO RELATED APPLICATION

This application claims the priority benefit of Taiwan application serial no. 099116163, filed on May 20, 2010. The entirety of the above-mentioned patent application is incorporated herein by reference and made a part of this specification.

### BACKGROUND

1. Technical Field

The present invention relates to a writing device and a writing method, and particularly to a writing device for electronic paper (E-paper) and a writing method thereof.

2. Description of the Related Art

With the development of electronic technology, a concept of E-paper is proposed. The E-paper is actually a flexible electrophoretic display. Generally, according to an electrophoretic layer in the electrophoretic display, a familiar type of the electrophoretic display is, for example, a micro-encapsulant electrophoretic display, or a micro-cup electrophoretic display. Currently, the electrophoretic display includes a thin film transistor array substrate for disposing the electrophoretic layer thereon. The thin film transistors of the thin film transistor array substrate are used for writing the pixels of the electrophoretic display so that the electrophoretic display can display a predetermined image.

However, the thin film transistors are precise and tiny electronic components, and are prone to being damaged by an external force or a bending action. Thus, the electrophoretic display with the thin film transistor array can not be carried easily.

### BRIEF SUMMARY

The present invention is directed to a writing method for E-paper. The writing method can write an E-paper without a writing circuit, thereby reducing the production cost of the E-paper and facilitating the convenience of carrying the E-paper.

The present invention is also directed to a writing device for E-paper to write an E-paper without a writing circuit.

The present invention provides a writing method for E-paper. The method includes the following steps. A writing device for E-paper is provided, which includes a first writing electrode and a second writing electrode. The first writing electrode and the second writing electrode face to each other. A writing space is defined between the first writing electrode and the second writing electrode. Next, an E-paper is disposed into the writing space of the writing device for E-paper. Next, a voltage is applied on the first writing electrode and/or the second writing electrode to form an electric field in the writing space. Next, the first writing electrode and the second writing electrode are driven to move with respective to the E-paper so that the E-paper is written by the electric field in the writing space.

In one embodiment of the present invention, the writing device for E-paper includes a shell. The first writing electrode and the second writing electrode both are disposed in the shell. The shell has an inserting opening. Thus, in the step of disposing the E-paper into the writing space of the writing device for E-paper, the E-paper is, for example, inserted into the writing device through the inserting opening.

The present invention provides a writing device for E-paper. The writing device includes a first writing electrode and a second writing electrode. The first writing electrode and the second writing electrode face to each other. A writing space is defined between the first writing electrode and the second writing electrode. The first writing electrode and the second writing electrode are configured for being driven to move with respective to the E-paper correspondingly.

In one embodiment of the present invention, the first writing electrode and the second writing electrode are configured for being driven to move with respective to the E-paper along a first axis and a second axis respectively.

In one embodiment of the present invention, the writing device for E-paper further includes a first driving module configured for driving the first writing electrode and the second writing electrode to move along the first axis and the second axis respectively.

In one embodiment of the present invention, the writing device for E-paper further includes a second driving module configured for driving the E-paper to move along the first axis and the second axis respectively in the writing space.

In one embodiment of the present invention, the writing device for E-paper further includes a first driving module and a second driving module. The first driving module is configured for driving the first writing electrode and the second writing electrode to move along the first axis. The second driving module is configured for driving the E-paper to move along the second axis in the writing space.

In one embodiment of the present invention, the writing device for E-paper further includes a shell. The first writing electrode and the second writing electrode both are disposed in the shell. The shell has an inserting opening and an exiting opening. The inserting opening and the exiting opening are located at two opposite sides of the writing space.

In one embodiment of the present invention, the first writing electrode and the second writing electrode each has a configuration of roller, and the first writing electrode and the second writing electrode are configured for clamping the E-paper cooperatively.

The writing method for E-paper can supply signals of an image to be displayed by using the writing device for E-paper to the E-paper so that the E-paper can display a predetermined image. Furthermore, it is not necessary for the E-paper to have the writing circuit. Thus, the production cost of the E-paper can be reduced and the E-paper can be carried easily.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a writing method for E-paper in accordance with an embodiment of the present invention.

FIG. 2 is a schematic view of a writing device for E-paper in a writing state in accordance with an embodiment of the present invention.

FIG. 3 is a schematic view of a writing device for E-paper in accordance with an embodiment of the present invention.

FIG. 4 is a schematic view of a driving mode of a writing device for E-paper in accordance with first embodiment of the present invention.

FIG. 5 is a schematic view of a driving mode of a writing device for E-paper in accordance with second embodiment of the present invention.

FIG. 6 is a schematic view of a driving mode of a writing device for E-paper in accordance with third embodiment of the present invention.

FIG. 7 is a schematic view of a driving mode of a writing device for E-paper in accordance with fourth embodiment of the present invention.

FIG. 8 is a schematic view of a driving mode of a writing device for E-paper in accordance with fifth embodiment of the present invention.

FIG. 9 is a schematic view of a driving mode of a writing device for E-paper in accordance with sixth embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

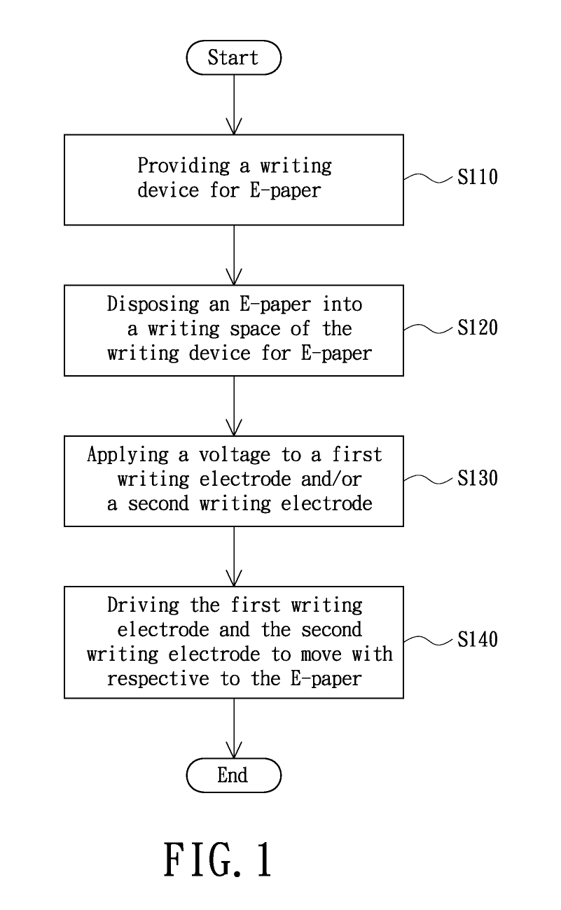

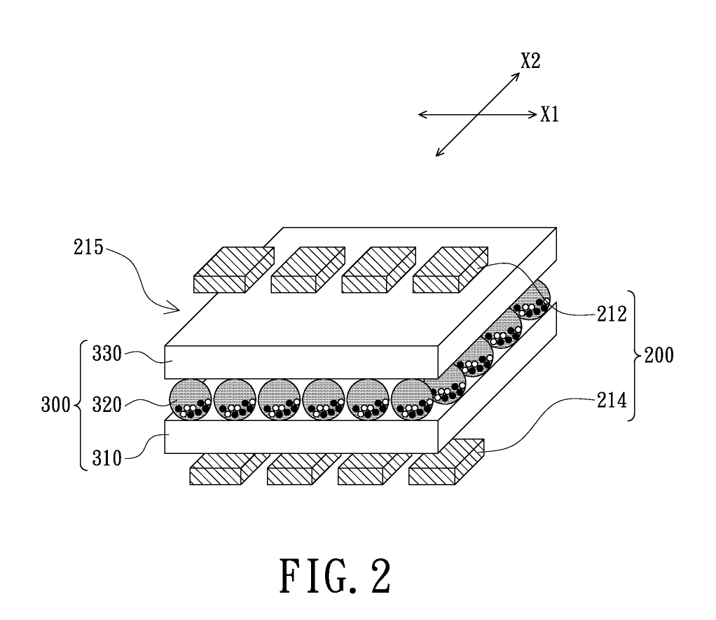

FIG. 1 is a flow chart of a writing method for E-paper in accordance with an embodiment of the present invention. FIG. 2 is a schematic view of a writing device for E-paper in a writing state in accordance with an embodiment of the present invention. Referring to FIG. 1 and FIG. 2, a writing method for E-paper includes the following steps. First, as shown in the step S110, a writing device for E-paper is provided. In the present embodiment, the writing device for E-paper 200 includes at least a first writing electrode 212 and at least a second writing electrode 214. The first writing electrode 212 and the second writing electrode 214 face to each other. A writing space 215 is defined between the first writing electrode 212 and the second writing electrode 214. In detail, the writing device for E-paper 200 includes, but not limited to, a plurality of first writing electrodes 212 and a plurality of second writing electrodes 214.

Referring to FIG. 2, the writing device 200 is configured for writing an E-paper 300. The E-paper 300 mainly includes a substrate 310, a displaying layer 320 and a protecting layer 330. The substrate 310 can include non-conductive flexible materials such as polyimide (PI), polyethylene terephthalate (PET), copper foil, aluminum foil or paper. Also, the substrate 310 can include non-conductive rigid materials such as glass and polycarbonate (PC). The displaying layer 320 can be an electrophoretic layer, for example, a micro-cup electrophoretic layer or a micro-capsule electrophoretic layer. Also, the displaying layer 320 can be, but not limited to, either a quick response liquid powder display (QR-LPD) layer or an electro-wetting layer. The protecting layer 330 is disposed on the displaying layer 320. The protecting layer 330 has characteristics of hardening surface, anti-glare, anti-reflective, anti-bacterial and anti-fingerprint.

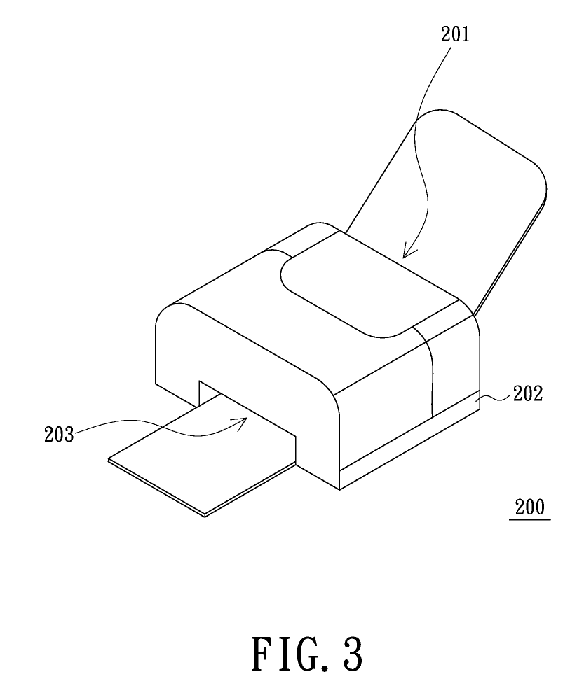

Next, as shown in the step S120, the E-paper 300 is disposed into the writing space 215 of the writing device for E-paper 200. In detail, in the present embodiment, the writing device for E-paper 200 includes, for example, a shell 202. The shell 202 has an inserting opening 201 and an exiting opening 203, as shown in FIG. 3. It is noted that FIG. 3 is a schematic view illustrating the present embodiment. Although an inner structure is not shown in FIG. 3, the first writing electrode 212 and the second writing electrode 214 shown in FIG. 2 are disposed in the shell 202. The inserting opening 201 and the exiting opening 203 are respectively located at two opposite sides of the writing space 215. In the present embodiment, the E-paper 300 is inserted into the writing device for E-paper 200 through the inserting opening 201. After the E-paper 300 is written, the E-paper 300 outs from the writing device for E-paper 200 through the exiting opening 203.

Again, referring to FIG. 1 and FIG. 2, as shown in the step S130, a voltage is applied to at least one of the first writing electrodes 212 and/or at least one of the second writing electrodes 214. An electric field is formed in the writing space 215 due to the difference of electric voltage between the first writing electrode 212 and the second writing electrode 214. Thus, molecules in the displaying layer 320 of the E-paper 300 in the writing space 215 are affected by the electric field to generate electrophoresis, thereby displaying a predetermined image on the E-paper 300.

Next, as shown in the step S140, after the voltage is applied to the first writing electrode 212 and/or the second writing electrode 214, the first writing electrode 212 and the second writing electrode 214 are driven to move with respective to the E-paper 300. Thus, the E-paper 300 is entirely written by the electric field in the writing space 215. Particularly, the first writing electrode 212 and the second writing electrode 214 can be driven to move with respective to the E-paper 300 in various manners. Thus, the writing device 200 has various driving modes correspondingly. The various driving modes are described, but not limited to, in the following embodiments.

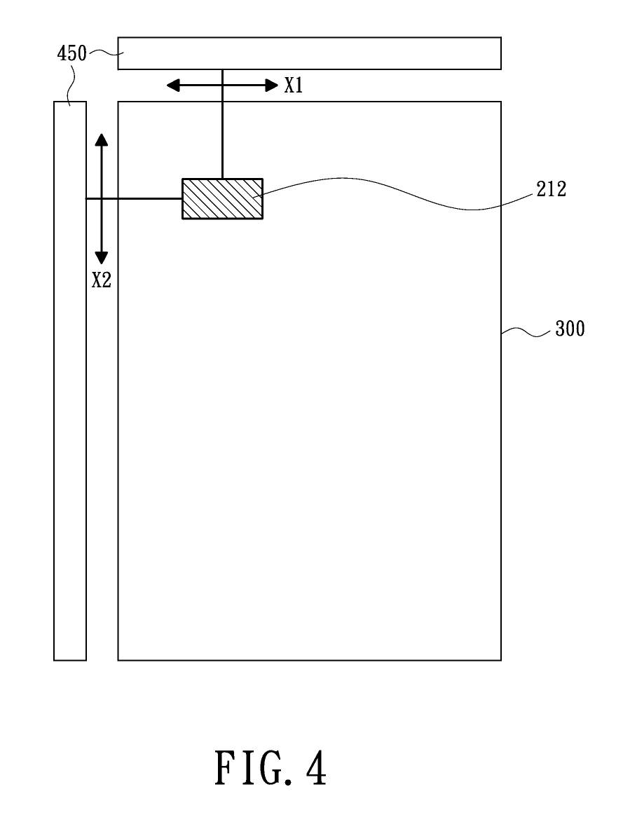

FIG. 4 is a schematic view of a driving mode of a writing device for E-paper in accordance with first embodiment of the present invention. Referring to FIG. 4, in the present embodiment, the writing device for E-paper 200 writes the E-paper 300 in a single point writing mode. In the present embodiment, the writing device for E-paper 200 only includes one first writing electrode 212 and one second writing electrode (not shown). The first writing electrode 212 and the second writing electrode are driven to move above the pixel unit to be written of the E-paper 300 in sequence. In FIG. 4, only the first writing electrode 212 is shown, and the second writing electrode is located below the first writing electrode 212 and is invisible. In detail, in the present embodiment, a first driving module 450 is configured for driving the first writing electrode 212 and the second writing electrode to move with respective to the E-paper 300 along a first axis X1 and a second axis X2 respectively.

As mentioned above, the E-paper 300 is fixed. First, the first driving module 450 drives the first writing electrode 212 and the second writing electrode to move with respective to the E-paper 300 along the first axis X1 above the pixels of a row to be written. Thus, the updating signals of the pixels are output to the corresponding pixel unit. Then, the first driving module 450 drives the first writing electrode 212 and the second writing electrode to move to the next row of the E-paper 300 along the second axis X2. As a result, all the pixels of the E-paper 300 are written one by one.

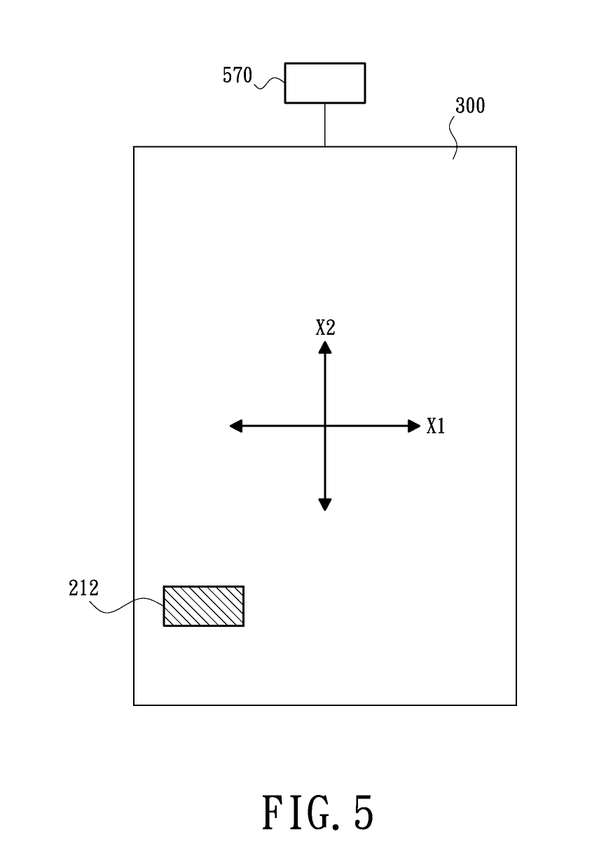

FIG. 5 is a schematic view of a driving mode of a writing device for E-paper in accordance with second embodiment of the present invention. Referring to FIG. 5, in the present embodiment, a second driving module 570 is configured for driving the E-paper 300 to move in the writing space (not shown) along the first axis X1 and the second axis X2 respectively. In other words, the present embodiment is similar to the first embodiment except the respective moving way. The E-paper 300 is driven to move in the present embodiment and the first writing electrode 212 and the second writing electrode are driven to move in the first embodiment.

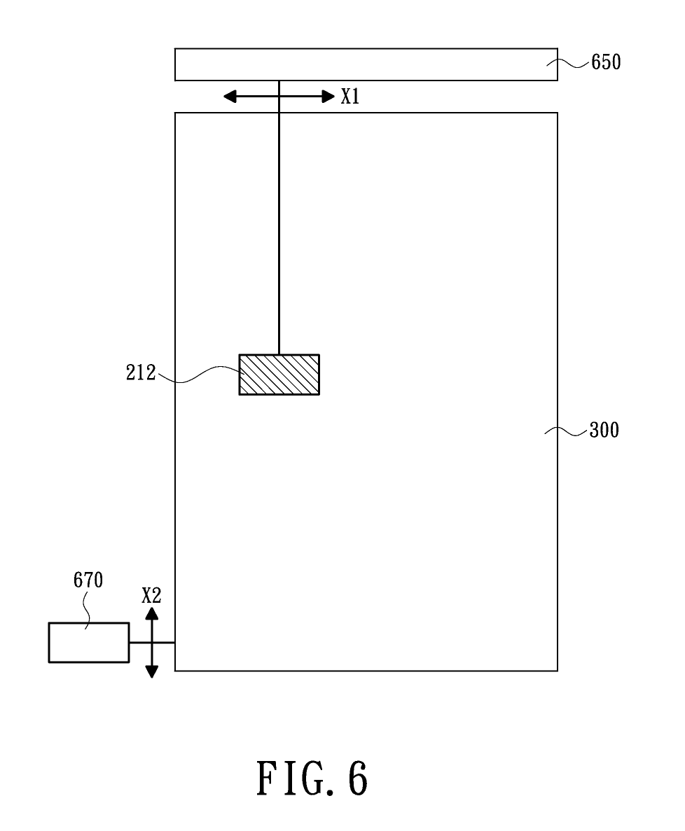

FIG. 6 is a schematic view of a driving mode of a writing device for E-paper in accordance with third embodiment of the present invention. Referring to FIG. 6, the first writing electrode 212 and the second writing electrode can be driven to move with respective to the E-paper 300. Or, the E-paper 300 can be driven to move with respective to the first writing electrode 212 and the second writing electrode. Otherwise, the first writing electrode 212, the second writing electrode, and the E-paper 300 can be driven to move with respective to each other. In the present embodiment, a first driving module 650 is configured for driving the first writing electrode 212 and the second writing electrode to move with respective to the E-paper 300 along the first axis X1. A second driving module 670 is configured for driving the E-paper 300 to move along the second axis X2 in the writing space 215. As a result, similar to the first embodiment, all the pixels of the E-paper 300 are written one by one.

In the aforesaid embodiments, a single point writing mode is described, but not limited hereto. Other writing modes will be described in the following embodiments.

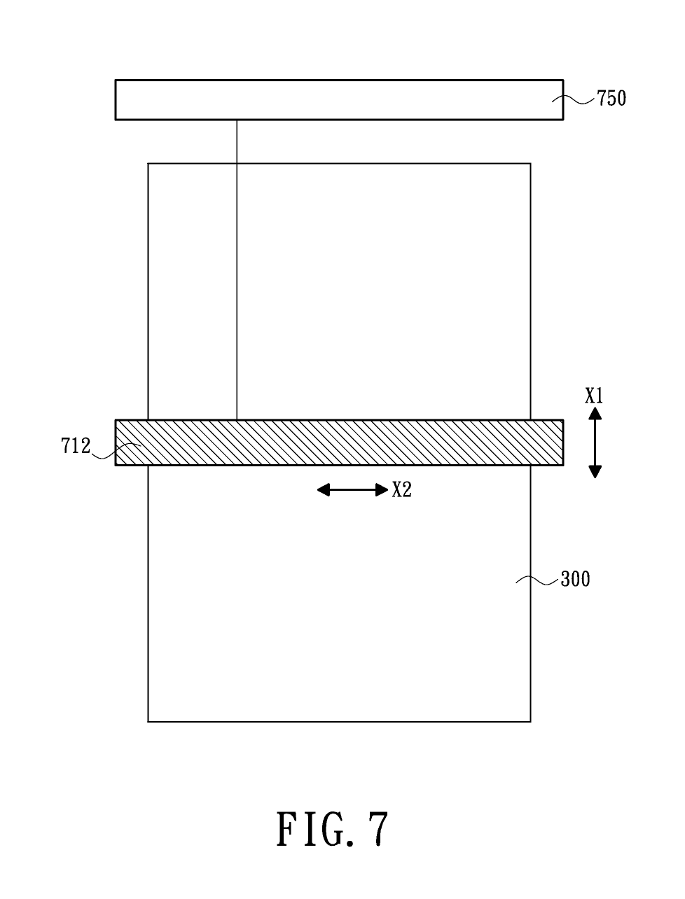

FIG. 7 is a schematic view of a driving mode of a writing device for E-paper in accordance with fourth embodiment of the present invention. Referring to FIG. 7, in the present embodiment, a first driving module 750 is configured for driving the first writing electrode 712 and the second writing electrode (not shown) to move with respective to the E-paper 300 along the first axis X1. As a result, the pixel units of each row arranged along the second axis X2 of the E-paper 300 can be written row by row.

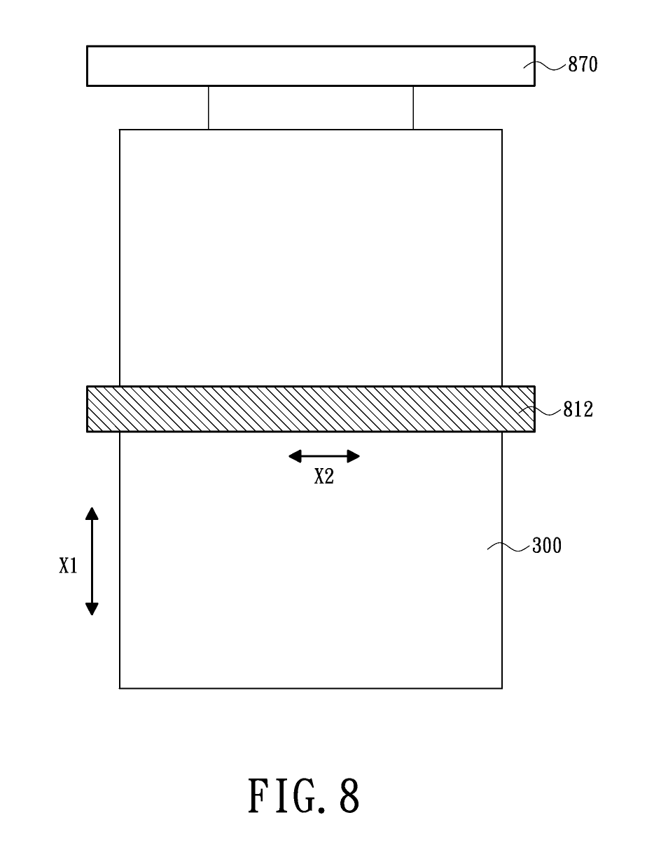

FIG. 8 is a schematic view of a driving mode of a writing device for E-paper in accordance with fifth embodiment of the present invention. Referring to FIG. 8, in the present embodiment, a second driving module 870 is configured for driving the E-paper 300 to move along the first axis X1. Thus, the first writing electrode 812 and the second writing electrode (not shown) can write the pixel units of each rows arranged along the second axis X2 of the E-paper 300 row by row.

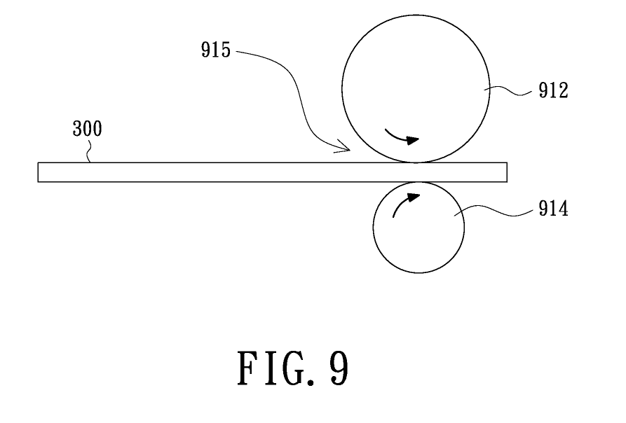

FIG. 9 is a schematic view of a driving mode of a writing device for E-paper in accordance with sixth embodiment of the present invention. Referring to FIG. 9, in the present embodiment, the first writing electrode 912 and the second writing electrode 914 both have a configuration of roller. The first writing electrode 912 and the second writing electrode 914 are configured for clamping the E-paper 300 cooperatively. The first writing electrode 912 and the second writing electrode 914 are driven to rotate towards two opposite directions. Thus, the E-paper 300 can be driven to move in the writing space 915, thereby being written by the first writing electrode 912 and the second writing electrode 914.

In summary, the writing method for E-paper can supply signals of an image to be displayed by using the writing device for E-paper to the E-paper so that the E-paper can display a predetermined image. Furthermore, it is not necessary for the E-paper to have the writing circuit. Thus, the production cost of the E-paper can be reduced and the E-paper can be carried easily.

It is noted that the E-paper in the aforesaid embodiments is, but not limited to, a black and white E-paper. Also, the E-paper can be a color E-paper. For example, a color filter can be disposed over the protecting layer of the E-paper to achieve a full color display of the E-paper. It is note that other suitable manners can be used to achieve a full color display of the E-paper.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A writing method for E-paper, comprising:
providing a writing device for E-paper, wherein the writing device for E-paper comprises at least a first writing electrode and at least a second writing electrode, the first writing electrode and the second writing electrode face to each other, and a writing space is defined between the first writing electrode and the second writing electrode;
disposing an E-paper into the writing space of the writing device for E-paper;
applying a voltage to the first writing electrode and/or the second writing electrode to generate an electric field in the writing space; and
driving the first writing electrode and the second writing electrode to move with respective to the E-paper so that the E-paper is written by the electric field in the writing space.

2. The writing method for E-paper as claimed in claim 1, wherein the writing device for E-paper comprises a shell for disposing the first writing electrode and the second writing electrode therein, the shell has an inserting opening, and the step of disposing the E-paper into the writing device for E-paper, includes the step of inserting the E-paper into the writing device through the inserting opening.

3. A writing device for E-paper, comprising:
a first writing electrode; and
a second writing electrode facing to the first writing electrode, a writing space being formed between the first writing electrode and the second writing electrode, and the first writing electrode and the second writing electrode being configured for being driven to move with respective to the E-paper correspondingly.

4. The writing device for E-paper as claimed in claim 3, wherein the first writing electrode and the second writing electrode are configured for being driven to move with respective to the E-paper along a first axis and a second axis respectively.

5. The writing device for E-paper as claimed in claim 4, further comprising a first driving module configured for driving the first writing electrode and the second writing electrode to move along the first axis and the second axis respectively.

6. The writing device for E-paper as claimed in claim 4, further comprising a second driving module configured for driving the E-paper to move along the first axis and the second axis respectively in the writing space.

7. The writing device for E-paper as claimed in claim 4, further comprising:
a first driving module configured for driving the first writing electrode and the second writing electrode to move along the first axis; and
a second driving module configured for driving the E-paper to move along the second axis in the writing space.

8. The writing device for E-paper as claimed in claim 3, further comprising a shell for disposing the first writing electrode and the second writing electrode therein, the shell has an inserting opening and an exiting opening located at two opposite sides of the writing space.

9. The writing device for E-paper as claimed in claim 3, wherein the first writing electrode and the second writing electrode each has a configuration of roller, and the first writing electrode and the second writing electrode are configured for clamping the E-paper cooperatively
